(19) United States
(12) Patent Application Publication
(10) Pub. No.: US 2014/0083413 A1
(43) Pub. Date: Mar. 27, 2014

(54) METHOD AND APPARATUS FOR MAPPING CLOUD SHADING ON THE GROUND IN A LARGE AREA

(71) Applicant: BrightSource Industries (ISRAEL) Ltd., Jerusalem (IL)

(72) Inventors: Ofir BIBI, Modiin (IL); Rotem HAYUT, Jerusalem (IL); Gil KROYZER, Jerusalem (IL)

(73) Assignee: BrightSource Industries (ISRAEL) Ltd., Jerusalem (IL)

(21) Appl. No.: 14/032,787

(22) Filed: Sep. 20, 2013

Related U.S. Application Data
(60) Provisional application No. 61/704,704, filed on Sep. 24, 2012.

(51) Int. Cl. G01W 1/02; F24J 2/40

(52) U.S. Cl. CPC G01W 1/02; F24J 2/40
USPC 126/601; 702/3

(57) ABSTRACT

Shading by clouds can affect the amount of flux on a heliostat which in turn can affect the energy generated by the solar device. Real-time monitoring of cloud shading of at least a portion of the solar field can allow for more efficient operation of the entire solar power system. For example, diffuse solar radiation and global horizontal radiation may be measured in certain parts of the field in order to estimate the direct normal radiation at any point in the solar field. A cloud map generated based on an image taken of the cloud may be used in calculating the direct normal radiation. By knowing the amount of direct normal radiation at any point in the solar field, the solar energy system can be changed or maintained. For example, the operating parameter may include aiming directions for one or more of the heliostats.

### CROSS-REFERENCE TO RELATED APPLICATIONS

The present application claims the benefit of U.S. Provisional Application No. 61/704, 704, filed Sep. 24, 2012, which is incorporated by reference herein in its entirety.

### FIELD

The present disclosure relates generally to solar energy systems, and, more particularly, to monitoring cloud shading in a solar field in order to maximize operations of a solar energy system.

### SUMMARY

In a field of heliostats, shading by clouds can affect the amount of flux on a heliostat which in turn can affect the energy generated by the solar device. Real-time monitoring of cloud shading of at least some of the heliostats can allow for more efficient operation of the entire solar power system. Where it is desired to know what the weather conditions are within a large geographic region (e.g., cloud cover over the geographic area) a weather station may be provided in or near the large region. However, weather conditions predicted by the weather station may not be indicative of the path of a cloud that shades only a part of the large area. More precise irradiation information concerning integral parts of the large areas would be beneficial.

Systems and methods for monitoring cloud shading in a large area are described. A large area may vary in size from less than a square kilometer to tens of square kilometers. For example, the large area can include a solar energy system with a solar field having sun-tracking elements. The solar field may range in size from a few hundred square meters to tens of square kilometers. According to some embodiments, insolation (irradiance or radiance) is measured on or near the ground in the large area. Examples of irradiance measured are global horizontal, diffused horizontal and direct normal radiation (DNR). Examples of devices for measuring and calculating DNR include, but are not limited to, pyrheliometers and rotating shadowband radiometers. Examples of a device for measuring total or global horizontal irradiance include, but are not limited to, pyranometers and photosensitive devices, such as a photovoltaic module with a measurable output.

Pyrheliometers and diffused horizontal radiation measurers provide high insolation resolution and low spatial resolution. Such devices may be relatively expensive and thus can be placed sparingly within the large area (e.g., in a relatively sparse distribution) to constitute a first spatial distribution of points. Pyranometers, which are relatively inexpensive as compared to pyrheliometers, can be arranged in a more dense distribution within the large area to constitute a second spatial distribution of points. Pyranometers densely placed provide high spatial resolution but low insolation resolution.

The different radiation features are constrained by the following equation:

GH=DH+DNR×cos(θ_{z})

where:
GH=Global Horizontal radiation
DH=Diffused Horizontal radiation
DNR=Direct Normal Radiation
θ_{z}=Degrees of the sun position vector from the zenith, or 90° minus the sun's elevation.

DNR is extracted from DH and GH by solving the above mentioned equation. Thus the combination of the two sensor types allow for a higher spatial resolution, which is a third (denser) spatial distribution of points.

A more dense third spatial resolution may be obtained with the additional use of digital light-responsive imaging equipment. For example, a digital imaging device can be a camera, such as a cloud camera. The cloud camera can be a fish eye camera or a camera configured to capture the image of a cloud on the ground, such as a camera mounted on an elevated location (e.g., on a tower, in an airborne vehicle, etc.).

Digital images of clouds in the sky are used for estimating or calculating the projection of a cloud's image from the sky onto the ground. Cloud height estimation for sky imaging can be obtained, for example, by capturing images of clouds with at least two cloud cameras and by using stereoscopy, weather information, and/or a ceilometer. It may also be useful to use the angle of the sun, especially when images of the sky are used for obtaining DNR. There are numerous means known to those skilled in the art to obtain the angle of the sun in the sky, for example, by using a Solar Position Algorithm (SPA) and/or by the use of available meteorological information. Other methods for obtaining the angle of the sun are also possible according to one or more contemplated embodiments.

The DNR measurement on a 2D area is extracted by using Diffused and Global sampling in different spatial sampling frequencies (distances between sensors). Using the combination of imaging devices and multiple sensors on the ground allows the determination of the cloud location in high resolution and the DNR under the cloud with high accuracy in both the radiation and spatial domains.

The above described cloud and/or DNR monitoring for a large area can also be performed with a DNR measuring instrument instead of or in combination with measuring diffuse horizontal radiation. In other words according to some embodiments, fewer DNR measuring devices coupled with more Global Horizontal Radiation devices may be used for obtaining a DNR measurement/matrix for a large area with good spatial and radiation resolution.

According to some embodiments, the method is used for predicting cloud movement and thereby the shading or lack of insolation across portions of a large area such as a solar field. Based on this prediction, the operation of a solar energy system can be adjusted to account for cloud shading movement across the solar field.

According to some embodiments, methods for mapping cloud shading on the ground in a large area can comprise the steps of measuring diffuse solar radiation received at a first spatial distribution of points in a large area to generate an estimation of the distribution of diffuse horizontal radiation (DH) over at least a part of the large area, measuring global solar radiation received at a second spatial distribution of points in the large area to generate an estimation of the distribution of global horizontal radiation (GH) over at least a part of the large area with the second distribution having a higher density of points than the first distribution, receiving an image responsive to light from the sky or the ground to generate an estimation of spatial distribution of clouds on the ground in at least part of the large area (a “cloud map”), and combining DH, GH, and estimating the sun's angle with the cloud map to generate an estimate of direct normal radiation (DNR) at a third spatial distribution of points in the large area. In some embodiments, the third distribution has a higher density than the second distribution.

In some embodiments, the methods may further comprise determining the height of the clouds. Cloud height can be determined by the use of at least one of: at least two cameras, a ceilometer and cloud-weather information.

In any of these embodiments, the combining may include deriving DNR from the equation

$$DNR = \frac{GH - DH}{cos ( {θ}_{Z} )}$$

and/or deriving an initial estimate of the DNR at the second distribution of points and extrapolating to the third distribution of points. The extrapolating may include classifying a point of third distribution according to whether direct radiation from the sun at that point is shadowed by a cloud responsively to the cloud map.

In some of these embodiments, the large area comprises one or more heliostats for redirecting insolation toward a solar target, and the method can further comprise controlling the heliostats responsively to the estimate of DNR.

According to other embodiments, methods for mapping cloud shading on the ground in a large area can comprise the steps of measuring direct normal radiation received at a first spatial distribution of points in a large area to generate an estimation of the distribution of direct normal radiation (DNR) over the large area, measuring global solar radiation received at a second spatial distribution of points in the large area to generate an estimation of the distribution of global horizontal radiation (GH) over the large area wherein the second distribution has a higher density than the first distribution, receiving an image responsive to light from the sky or the ground to generate an estimation of spatial distribution of clouds (cloud map), and combining DNR, and GH and estimating the sun's angle with the cloud map to generate an estimate of direct normal radiation (DNR) at a third distribution of points in the large area. In some of these other embodiments, the third distribution has a higher density than the first and/or the second distribution. In some of these other embodiments the combining can include deriving an initial estimate of the DNR at said second distribution of points and extrapolating to said third distribution of points, and the extrapolating can include classifying a point of third distribution according to whether direct radiation from the sun at that point is shadowed by a cloud responsively to the cloud map.

In some of these other embodiments, the large area can comprise a solar field comprising one or more heliostats for redirecting insolation toward a solar target, and the method can further comprise controlling the heliostats responsively to the estimate of DNR. The method may further comprise determining the height of the clouds and an estimate of the angle of the sun if the image is of the sky. Cloud height can be determined by the use of at least one of: at least two image capturing devices, a ceilometer and cloud-weather information.

In alternative embodiments, methods for mapping cloud shading on the ground in a solar energy field can comprise the steps of measuring at least one of diffused solar radiation (DH) and direct normal radiation (DNR) received at an area defined by a first spatial distribution of points within the solar field to generate an estimation of the distribution of DH and/or DNR over at least part of the solar field, measuring global solar radiation (GH) received at an area defined by a second spatial distribution of points within the solar field to generate an estimation of the distribution of GH, wherein the second distribution of points has a higher density of points than the first distribution, and combining solar radiation measured by DH and/or DNR and GH and estimating the sun's angle, to generate an estimate of direct normal radiation (DNR) at a third distribution of points in the solar field. In some embodiments, the methods can further comprise receiving an image responsive to light from the sky or the ground to generate an estimation of spatial distribution of clouds on the ground in at least part of the solar field (cloud map), where a shaded area of the solar field is defined by the estimated spatial distribution of clouds. The shaded area on the solar field can contain none or a small amount of the first and/or second distribution of points.

The methods can further comprise any of: using the cloud map to determine which of the points from the first and second distribution shall be used for calculating the solar radiation value in each of the points in the third distribution of points; combining DH and/or DNR solar radiation and GH, with the cloud map to generate an estimate of direct normal radiation (DNR) at a third distribution of points in the solar field; and determining the height of the clouds.

Objects and advantages of embodiments of the disclosed subject matter will become apparent from the following description when considered in conjunction with the accompanying drawings.

### BRIEF DESCRIPTION OF DRAWINGS

Embodiments will hereinafter be described with reference to the accompanying drawings, which have not necessarily been drawn to scale. Where applicable, some features may not be illustrated to assist in the illustration and description of underlying features. Throughout the figures, like reference numerals denote like elements.

FIG. 1 is a schematic diagram of a heliostat control system, according to one or more embodiments of the disclosed subject matter

FIG. 2 shows a solar power tower system illustrating individual heliostats, a tower and clouds, according to one or more embodiments of the disclosed subject matter.

FIGS. 3-5 show clouds shading heliostats as the cloud moves across the solar field according to one or more embodiments of the disclosed subject matter.

FIG. 6 is a schematic diagram of a large area with a first and second distribution of radiation measuring devices, according to one or more embodiments of the disclosed subject matter.

FIG. 7 shows a direct normal radiation map of a large area with overhead clouds, according to one or more embodiments of the disclosed subject matter.

FIG. 8 shows a diffused horizontal radiation map of a large area with overhead clouds, according to one or more embodiments of the disclosed subject matter.

FIG. 9 shows a solar power tower system with a portion of the heliostat field shaded by one or more clouds and an image capturing device on a tower, according to one or more embodiments of the disclosed subject matter.

FIGS. 10-12 show three solar fields in a solar power tower system with radiation measuring devices and a cloud shading portions of the solar fields, according to one or more embodiments of the disclosed subject matter.

### DETAILED DESCRIPTION

Systems and methods for monitoring cloud shading in a large area are described. Embodiments of the present disclosure relate generally to solar energy systems that include at least one solar field and numerous devices (e.g., heliostats) for redirecting insolation toward a solar target. Solar targets can be configured to convert insolation into another form of energy, e.g., electricity (for example, by using photovoltaic cells), thermal energy (for example, by using solar thermal systems), or biofuels. A plurality of heliostats can track the sun to reflect incident sunlight onto receivers on or in a solar target, for example, at or near the top of a solar tower. The solar receivers can be constructed to heat water and/or steam and/or supercritical steam and/or another type of heat transfer fluid using insolation received from the heliostats. For example, the solar tower can have a dimension of at least 25 meters, at least 50 meters, at least 100 meters, at least 150 meters, or even higher.

Heliostats can adjust their orientation to track the sun as it moves across the sky, thereby continuing to reflect sunlight onto one or more aiming points associated with the solar energy receiver system. The aiming point on the receiver may be defined as the area of the receiver upon which the heliostats reflects light. The aiming point is not necessarily a finite point or area on the receiver and may change depending on the operational needs of the system.

According to some embodiments, heliostats are aimed in response to instructions generated by a control computer and transmitted to the heliostats through a communication system. The aiming instructions and the optimization methods used to generate those instructions can be responsive to the cloud data obtained through the methods and apparatus disclosed in any of the embodiments herein. This responsiveness may include causing a heliostat to move from an aiming point not on a receiver to an aiming point on a receiver, from an aiming point on a receiver to an aiming point not on a receiver, from one aiming point on a receiver to another aiming point on the same receiver, or from an aiming point on one receiver to an aiming point on another receiver, or to/from any other location.

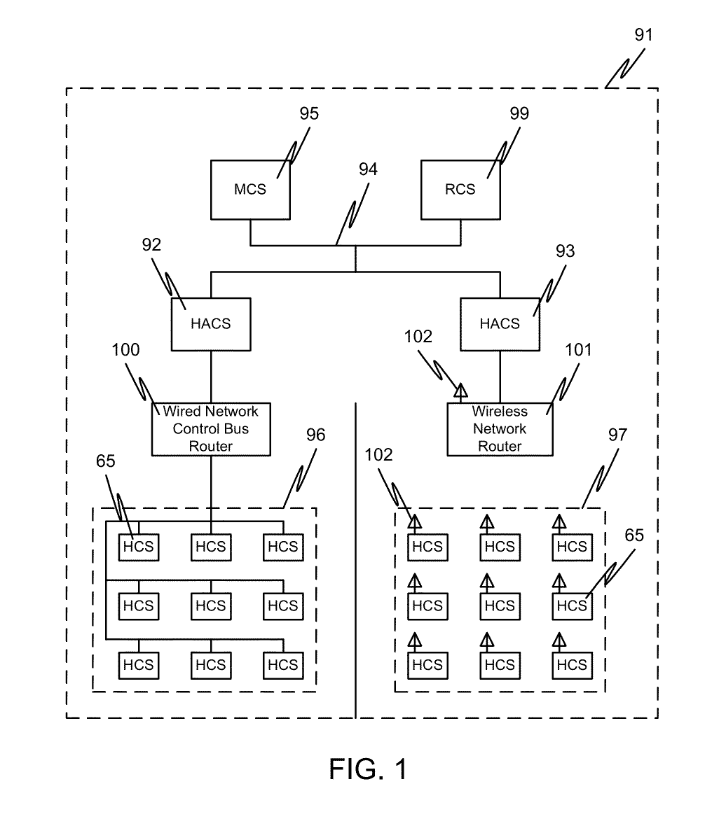

Heliostats in a field can be controlled through a central heliostat field control system 91, for example, as shown in FIG. 1. For example, a central heliostat field control system 91 can communicate hierarchically through a data communications network with controllers of individual heliostats. FIG. 1 illustrates a hierarchical control system 91 that includes three levels of control hierarchy, although in other implementations there can be more or fewer levels of hierarchy, and in still other implementations the entire data communications network can be without hierarchy, for example, in a distributed processing arrangement using a peer-to-peer communications protocol.

At a lowest level of control hierarchy (i.e., the level provided by heliostat controller) in the illustration there are provided programmable heliostat control systems (HCS) 65, which control the two-axis (azimuth and elevation) movements of heliostats (not shown), for example, as they track the movement of the sun. At a higher level of control hierarchy, heliostat array control systems (HACS) 92, 93 are provided, each of which controls the operation of heliostats (not shown) in heliostat fields 96, 97, by communicating with programmable heliostat control systems 65 associated with those heliostats through a multipoint data network 94 employing a network operating system such as CAN, Devicenet, Ethernet, or the like. At a still higher level of control hierarchy a master control system (MCS) 95 is provided which indirectly controls the operation of heliostats in heliostat fields 96, 97 by communicating with heliostat array control systems 92, 93 through network 94. Master control system 95 further controls the operation of a solar receiver (not shown) by communication through network 94 to a receiver control system (RCS) 99.

In FIG. 1, the portion of network 94 provided in heliostat field 96 with a large area can be based on copper wire or fiber optics connections, and each of the programmable heliostat control systems 65 provided in heliostat field 96 is equipped with a wired communications adapter, as are master control system 95, heliostat array control system 92 and wired network control bus router 100, which is optionally deployed in network 94 to handle communications traffic to and among the programmable heliostat control systems 65 in heliostat field 96 more efficiently. In addition, the programmable heliostat control systems 65 provided in heliostat field 97 communicate with heliostat array control system 93 through network 94 by means of wireless communications. To this end, each of the programmable heliostat control systems 65 in heliostat field 97 is equipped with a wireless communications adapter 102, as is wireless network router 101, which is optionally deployed in network 94 to handle network traffic to and among the programmable heliostat control systems 65 in heliostat field 97 more efficiently. In addition, master control system 95 is optionally equipped with a wireless communications adapter (not shown).

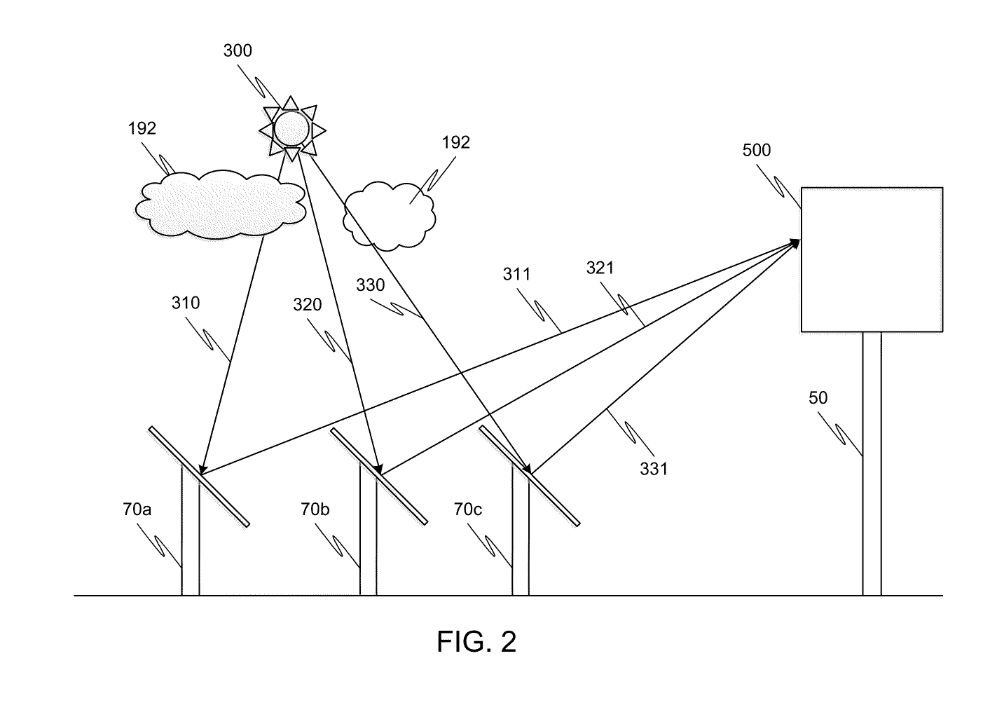

As shown in FIG. 2, the heliostat field can include one or more heliostats, for example, sun-tracking mirrors aimed at a target for heating a material therein using reflected sunlight. For example, the heated material can be water, molten salt, or any other material. Heliostats 70a, 70b and 70c within the field can be aimed at a target, i.e., solar energy receiving system 500, mounted on tower 50. In operation, sunlight beams 310, 320, 330 from the sun 300 can strike the reflective surface of heliostat mirrors 70a, 70b and 70c, respectively. The heliostats may then reflect beams 311, 321, 331 towards the receiver 500. The reflected rays 311, 321, 331, in addition to beams reflected from other heliostats in the field, can heat the material within receiver 500 to temperatures of between 400° C. and 800° C.

In a field of heliostats, shading by clouds can affect the amount of flux on each heliostat which in turn can affect the energy generated by the solar system. Real-time monitoring of clouds shading at least some of the heliostats can allow for more efficient operation of the entire solar energy system. When clouds pass between the sun and the heliostats, direct insolation is temporarily interrupted or reduced. As a result, the radiation reflected onto a solar receiver may differ from an ideal or expected flux distribution. This can result in local variations in temperature or flux that could damage the receiver. Moreover, the variations in flux can result in less than ideal operating conditions, for example, a reduction in steam produced or the temperature of the superheated steam.

FIG. 2 illustrates an instance when clouds shadow heliostats. This interruption of insolation can be seen by clouds 192 shadowing sun 300 from heliostats 70a and 70c, while heliostat 70b continues to receive uninterrupted insolation.

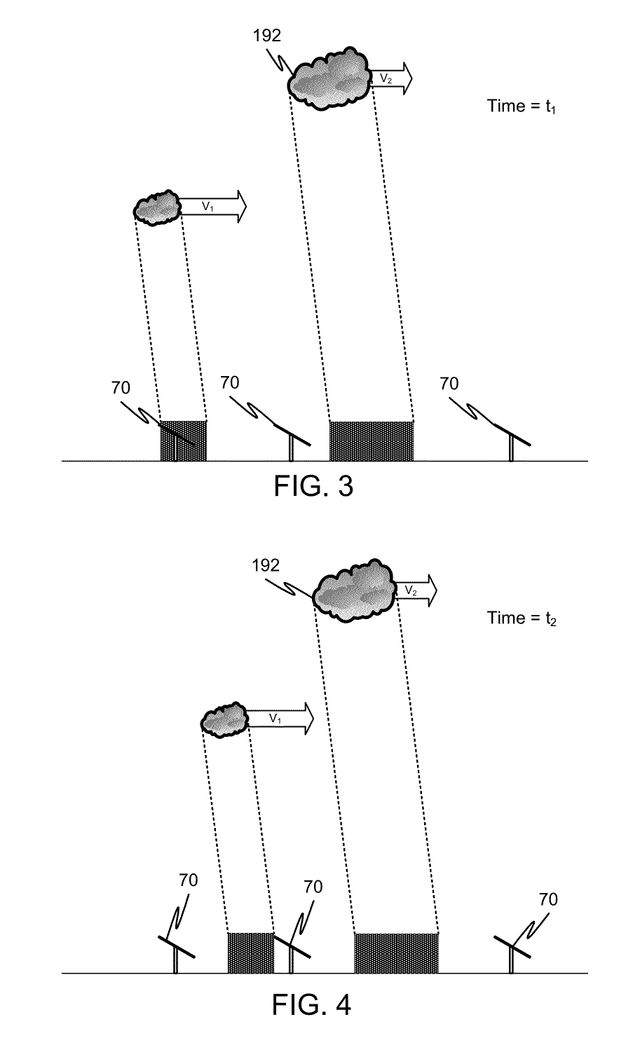

In some embodiments, by monitoring incident insolation on or near heliostats in a solar field, a shading parameter may be computed. For example, as illustrated in FIGS. 3-5, a shading parameter can be computed based on a trajectory of one or more clouds 192 moving across the field during three consecutive times t₁, t₂, and t₃. The time series images can help predict a future shadow status with respect to the heliostat field.

Characterization of a cloud shadow movement can include determining a shape of the shadow, a value for irradiance, a translational velocity of the shadow, and/or a rotational velocity of the shadow so as to determine and/or predict movement of the cloud shadow with respect to the field of heliostats or other components of the solar energy system. The determined shadow can depend upon a number of factors, including but not limited to the position of the sun as determined in advance from astronomical data, such as day of the year, time of day, and geographic location. Accordingly, the shading parameter can include a future shading parameter. The operating may thus be carried out preemptively based at least in part on the future shading parameter.

In some embodiments, the pre-emptive operation can be related to fossil-fuel derived steam. For example, in the event that the cloud image analysis indicates that an evaporator region of the heliostat field (i.e., a region of the heliostat field where the heliostats are aimed at an evaporator section of the receiver) is about to be shaded within a designated period of time, then it may be advantageous to initiate a natural gas boiler to be on-call. When shading causes a decrease in insolation on the evaporator, the natural gas boiler can produce steam which is injected into the steam separation drum associated with the evaporator/boiler to compensate for the reduced insolation condition. Alternatively or additionally, a pre-emptive operation relates to re-aiming of heliostats. Because heliostats may need a certain amount of travel time to re-aim, it may be advantageous in anticipation of predicted or future shade conditions to re-aim the heliostat before it becomes shaded.

In some embodiments, a location of a shadow at or near ground level produced by a cloud in the sky and/or a shape or size of a shaded region at or near ground level produced by the cloud is determined.

In some embodiments, a small number of diffused horizontal (DH) radiation measurers and a larger number of global radiation sensors are positioned in a large area where they monitor radiation therein. Each position of a device for measuring radiance may constitute a point and the distribution of points of the DH radiation measurers (sparsely placed) can constitute a first spatial distribution of points. Alternatively or additionally, a number of sparsely placed direct normal radiation (DNR) measuring devices are placed in the large area and may be considered as the first spatial distribution of points.

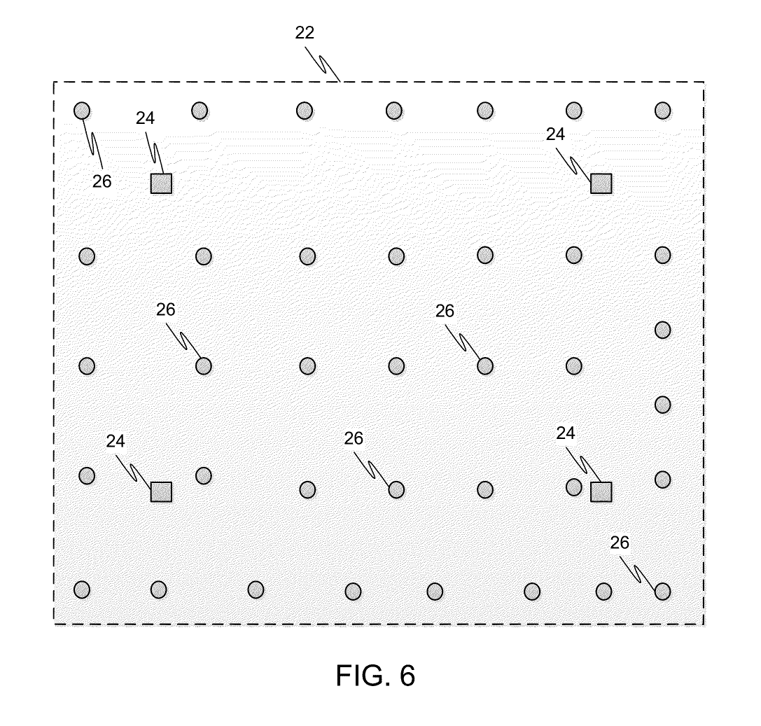

The locations of global horizontal (GH) radiation measuring devices form a second spatial distribution of points. The distribution density in the second spatial distribution is higher than the distribution density of the first spatial distribution of points. FIG. 6 illustrates a non-limiting example of a large area 22 having a first distribution of points 24 and a second more dense distribution of points 26. The relatively sparse first distribution of points represent devices for measuring DH and/or DNR and the more dense second distribution of points represent the relatively inexpensive GH measuring devices.

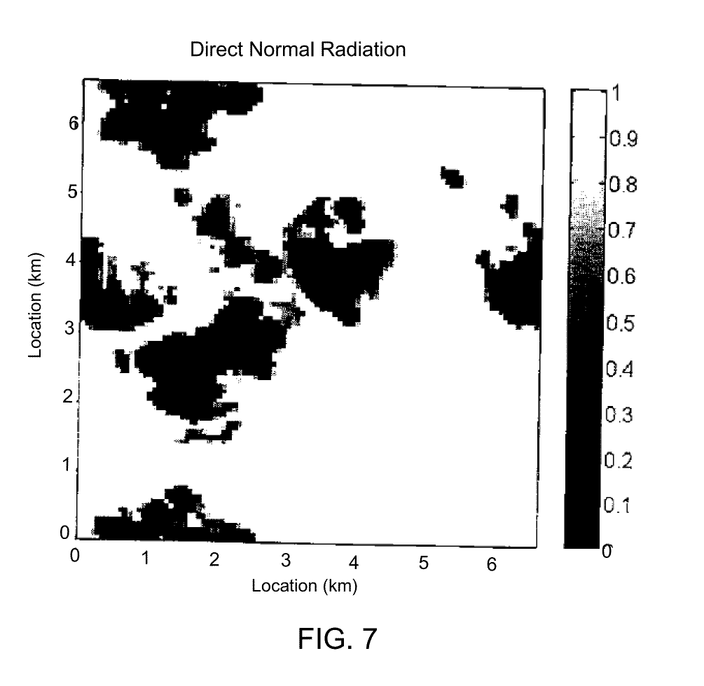

As illustrated in FIG. 7, a DNR map (cloud shading shown in black) is a matrix with high spatial resolution and good accuracy. Such a map may be created without necessarily using a large number of DNR and/or diffused irradiation measuring devices, thereby reducing costs over conventional arrangements. Global radiation may be measured with the aid of a pyranometer.

Diffused, Direct and Global radiation are constrained by the following equation:

GH=DH+DNR×cos(θ_{z}) (1)

where:

GH=Global Horizontal radiation;

DH=Diffused Horizontal radiation;

DNR=Direct Normal Radiation;

θ_{z}=the zenith angle−the angle between the location of the sun and the local zenith.

DNR may be measured and calculated by the use of dedicated devices such as pyrheliometers. In a pyrheliometer, sunlight enters the instrument through a window with a narrow field of view and is directed onto a thermopile which converts heat to an electrical signal that can be recorded. The signal voltage is converted via a formula to measure watts per square meter. It may be used in conjunction with a solar tracking system to keep the instrument aimed at the sun. A pyranometer which measures global radiation can be used to measure diffused irradiation by shading the direct radiation from the pyranometer. Direct sunlight (DNR) may then be calculated by a computer program. There are numerous commercially available devices for measuring and calculating DNR, DH and GH.

Devices that measure Global Horizontal Irradiance such as pyranometers may be relatively inexpensive. According to one or more embodiments, pyranometers can be placed relatively densely in points across a large field such as a solar energy field. Devices that measure diffused horizontal or direct horizontal radiance such as pyrheliometers can be more expensive than pyranometers, and, according to one or more embodiments, may be positioned more sparsely in the large area.

In order to detect clouds and monitor the path of a cloud or clouds shading at least a portion of the large area such as a solar field, the direct normal radiation incident on as many points as possible in the field can be measured. This is especially relevant for a solar field with heliostats as heliostats reflect insolation (direct sunlight) onto the one or more receiver. Devices for directly measuring DNR or for diffused radiation can be expensive. In addition, such devices may be limited to radiation detection for only a single point where they are located. Moreover, due to the sharp edges of the DNR values in space during cloud cover time, creating a DNR map on a large scale surface area may require many sampling points of the DNR value, which may require significant expense in terms of capital outlay and maintenance.

In contrast, global radiation sensors (e.g., pyranometers), while still measuring at a single point, may be much more inexpensive than these sensors, mostly due to the lack of need to track the sun position. The global radiation sensors may be positioned in the large area more densely than DNR and/or DH measuring/calculating devices. However, GH measuring devices do not differentiate between direct sunlight and total radiation. It is the amount of direct insolation that is the most relevant data for heliostats. In some embodiments, other photosensitive devices with measurable outputs (e.g., devices not necessarily dedicated to measuring GH) may be used to measure GH and to generate at least a portion of the second distribution of points. For example, a photovoltaic panel associated with a heliostat may have a measurable output that is proportional to GH.

Both the points of the first and second spatial distribution may originate from a number of types of devices and be part of a composite radiation matrix of the large area. According to embodiments, devices for measuring and calculating diffused horizontal radiation (DH) may be used for the first distribution of points. An example of a diffused radiation measurer is a BF5 Sunshine Sensor™ manufactured by Delta-T Devices.

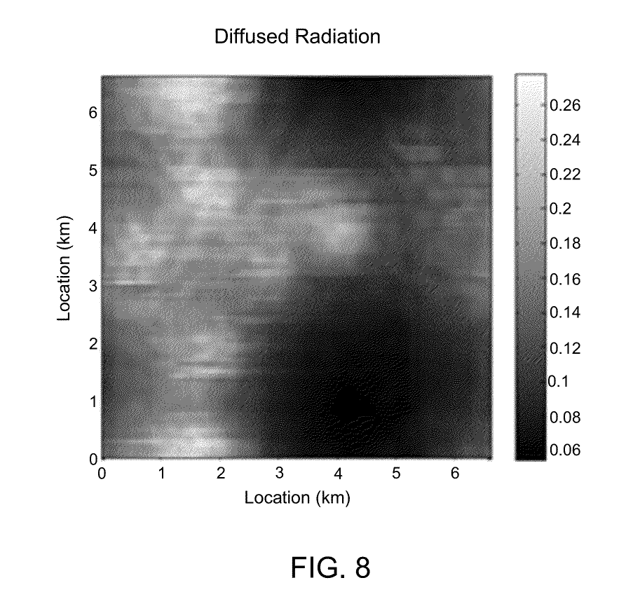

The advantage of using a device for measuring DH for the first distribution as opposed to DNR measuring devices is that DH changes more slowly in space. Therefore, interpolation can be done over a large area while maintaining a good bound on the error as illustrated in FIG. 8. As DH measurements are collected from the first distribution points, the DH on the entire field may be interpolated in order to calculate the DNR from the GH in the second distribution of points. If direct DNR measurements are used instead of collecting radiation data from DH measuring devices, the measurements will show very rapid drops when clouds cover the measuring devices. Without the use of many such devices, interpolation of the data becomes very difficult. Many DNR devices as opposed to less DH devices are necessary for an interpolation that would reflect the cloud shading in the large area. In the case of using DNR devices in the first distribution of points, GH measuring devices can also be included in the first distribution of points in order to calculate the DH in the first distribution of points and interpolate the data based on the calculated DH values.

In a solar field with heliostats, it may be useful to know the amount of direct sunlight at any point in the solar field in order to monitor cloud movement over the large area. As illustrated in FIG. 8, a diffused radiation map is relatively smooth and has a low spatial frequency, which enables measurement of the diffused radiation layer in a lower spatial resolution (e.g., sensors relatively remote from their neighbors). DNR and global radiation maps have sharper edges, meaning that they would require a high sampling rate in order to obtain good accuracy. The DNR layer can be extracted from both the diffused and the GH radiation layers, using Eqn. (1) above, with a high spatial resolution.

In order to further decrease the amount of sampling points of the sharp edges, imaging devices responsive to light may be utilized to capture images of clouds either in the sky, or on the ground, for example, by using a cloud camera to estimate or calculate the projection of the cloud on the ground. An example of a cloud camera is a fish eye camera or a wide-angle camera. An imaging device can therefore provide more precise information on the exact location of a cloud and its boundaries, i.e., a higher spatial resolution. When using a camera alone there is very little, if any, radiation resolution apart from a positive or negative concerning cloud cover at a certain point on the ground. Instead, the radiation resolution is provided by the radiation measuring devices.

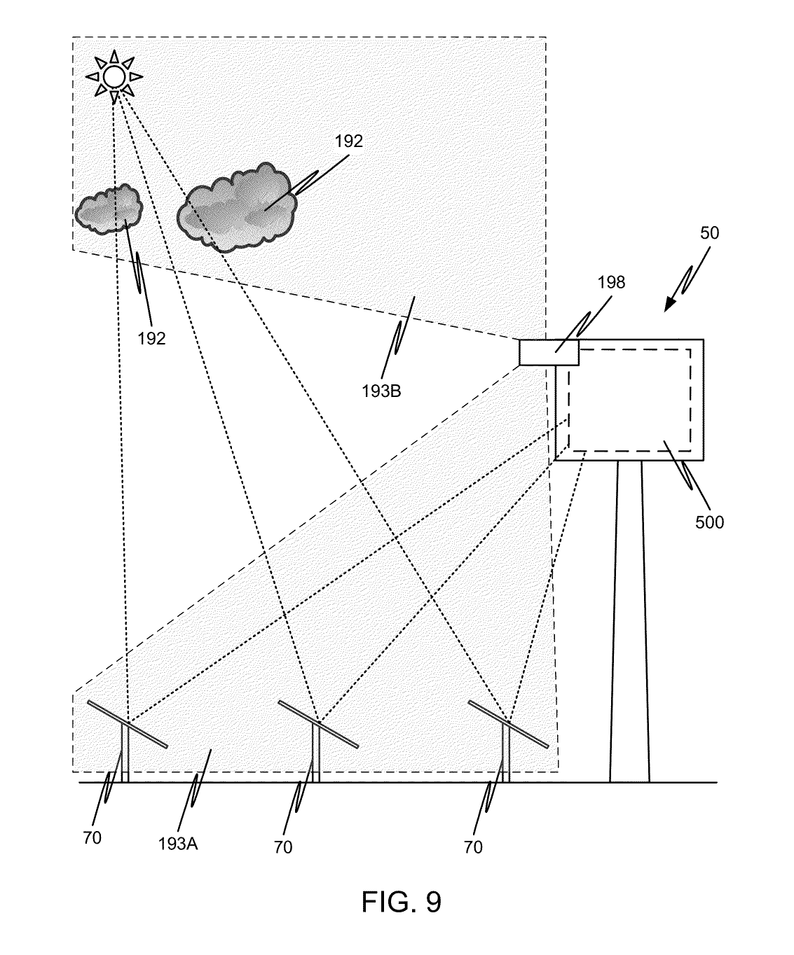

In the embodiment of FIG. 9, a locally deployed imaging system 198 is arranged so as to acquire substantially local images indicative of cloud cover 192 over (or in the vicinity of) at least a part of large area such as a field of heliostats 70. To obtain such images, the imaging device 198 may be configured to image at least a portion of the field of heliostats, for example, by having a field of view 193A aimed at the ground, thereby obtaining images of shadows cast by passing clouds 192. Alternatively or additionally, the imaging device can be arranged to image at least a portion of the sky, for example, by having a field of view 193B, in order to determine the location of shadows in the field of heliostats. Embodiments may include combinations of imaging devices that are aimed at the field of heliostats and the sky.

As shown in FIG. 9, an imaging system may include one or more imaging devices 198 arranged for example on tower 50 as shown. For example, imaging device 198 can be a charge-coupled device (CCD), complementary metal oxide semiconductor (CMOS), or any other type of imager. The imaging device 198 can be arranged at or near the top of tower 50, for example, on or adjacent to the solar energy receiving system 500. Alternatively or additionally, one or more of the imaging devices 198 can be arranged on different towers, within the heliostat field, above the heliostat field, or outside of the heliostat field (not shown). The imaging device 198 can be arranged within the confines of the heliostat field, or at a distance from the heliostat field that is, for example, less than 20 km, or less than 10 km, or less than 5 km, or less than 500 m.

The acquired images can be used to determine a shading parameter of the heliostat field. In addition, the imaging device 198 can be configured to provide one or more images at different times, for example, to provide time-lapse imaging (FIGS. 3-5). For example, the images from the one or more imaging devices 198 can be analyzed by a processor (not shown) to determine the shading parameter. Examples of the shading parameter include but are not limited to: (i) a subset of the heliostats in the field of heliostats that are substantially shaded by clouds or that are substantially free of cloud shade, (ii) the dimensions of one or more shadows that cover a fraction of the heliostat field, and (iii) relative shade strengths at one or more distinct locations within the field of heliostats.

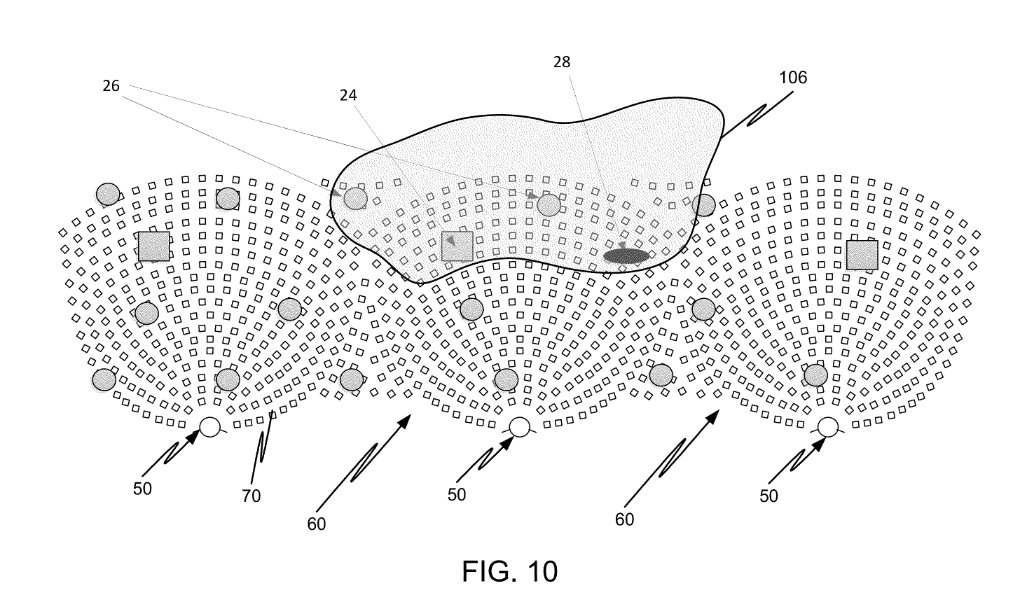

The assumption that the cloud boundaries have sharp edges enables the determination of a value for each cloud or clear area based on the measurement of a single sensor in a single point within this boundary in a model. As an example of use, FIG. 10 illustrates a large area including of a plurality of solar fields 60 which may include a number of receiving towers 50 and a plurality of heliostats 70. In the solar field there may be a relatively small amount of DH measuring/calculating devices 24, at a first spatial distribution of points and more GH measuring devices at a second spatial distribution of points, with examples depicted 26. The actual distribution of GH measuring devices may be greater than the examples 26 illustrated in FIG. 10. The amount of measuring devices 24, 26 in FIGS. 10-12 may be less or greater than the actual amount of devices used.

A cloud 106 is illustrated shading some of the solar field 60. Within the shading of cloud 106 one DH measuring device 24 is depicted as well as two GH measuring devices 26. As described above, measurements from the devices within the cloud shading may be used to compute a DNR value for a point 28. The third distribution of points inside the cloud shadow and the image taken either of the sky by a cloud camera and digital images of clouds in the sky (e.g., used for estimating or calculating the projection of a clouds image from the sky onto the ground) or of the ground from a high place can be used to define the perimeter area of the computed DNR value. This calculation may be accomplished in accordance with Eqn. (1) above. The first distribution of points may be the sparsest, i.e., the fewest number of the DH or DNR measuring devices. The second distribution of points may be more dense than the first distribution of points, as the number of GH measuring devices, may be greater than the number of DH and DNR measuring devices. As the third distribution of points can be anywhere within the shaded part of the solar field 106, the density of the third distribution is potentially or actually greater than the first or second spatial distribution of points.

Although the above operating parameters relate to heliostat field operation, the available operating parameters are not limited thereto. In embodiments, the operating parameter of a portion of the solar energy system other than the heliostat field may be modified, established, and/or maintained according to the shading parameter. In a non-limiting example, the north surface of the tower can have an evaporator/boiler and the south surface of the tower can have a superheater. In the event that the calculated and predicted DNR and acquired image indicates that the heliostats that typically reflect insolation to the north end are shaded or about to be shaded, without substantial shade to the south side where the superheater resides, then it may be advantageous to inject steam into a steam separation drum deployed between the boiler and the superheater. In the event that the calculated and predicted DNR and the acquired image indicates that the heliostats that typically reflect insolation to the south end are shaded or about to be shaded, without substantial shade to the north side where the evaporator/boiler is, then it may be advantageous to lower a turbine operating pressure, for example, in advance of the oncoming shadow.

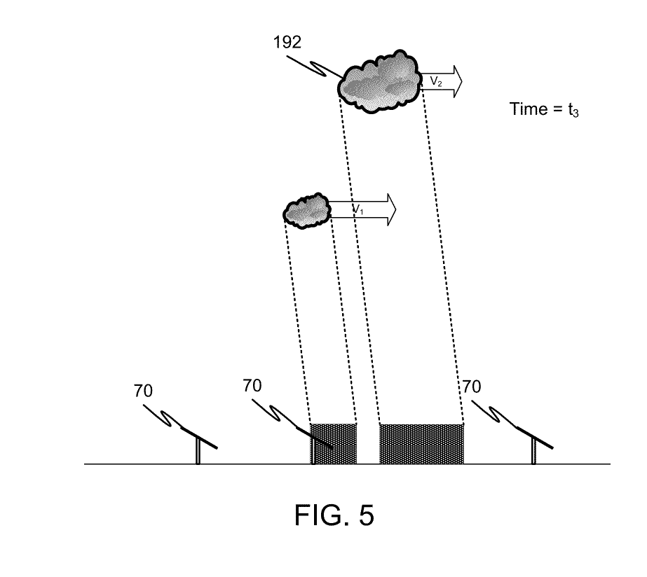

In some embodiments, it is possible to acquire a time series of images to estimate a trajectory of one or more clouds, for example, as illustrated in FIGS. 3-5. The time series images can help predict a future shadow status with respect to the heliostat field. As illustrated, clouds 192 make their way above a field of heliostats 70, and are illustrated at three consecutive times, t₁ (FIG. 3), t₂ (FIG. 4) and t₃ (FIG. 5), with the translational velocity of the two clouds depicted by vector v₁ and v₂.

The shading parameter can include a future shading parameter, and the operating can be carried out preemptively. In embodiments, the pre-emptive operation can be related to fossil-fuel derived steam. For example, in the event that the cloud image analysis indicates that an evaporator region of the heliostat field (i.e., a region of the heliostat field where the heliostats are aimed at an evaporator section of the receiver) is about to be shaded within a designated period of time, then it may be advantageous to initiate a natural gas boiler to be on-call. When insolation levels decrease, natural-gas-derived steam can be injected into the steam separation drum associated with the evaporator/boiler. Alternatively it may be advantageous to gradually re-aim heliostats away from the receiver in advance of the future cloudy conditions to avoid a sudden loss of flux on the receiver surface when the clouds arrive.

In some embodiments, a pre-emptive operation relates to re-aiming of heliostats. Because heliostats may need a certain amount of travel time to re-aim, then it may be advantageous in anticipation of predicted or future shade conditions to re-aim before the heliostat becomes shaded.

In some embodiments, a location of a shadow at or near ground level produced by a cloud in the sky and/or a shape or size of a shaded region at or near ground level produced by the cloud is determined. For example, movement of a shadow (i.e., a cloud) as it moves across heliostats 70 can be tracked, as shown in FIGS. 3-5. Characterization of such movement can include determining a shape of the shadow, a translational velocity V₁ and V₂ of the shadow, and/or a rotational velocity of the shadow so as to determine and/or predict movement of the cloud shadow with respect to the field of heliostats or other components of the solar energy system. The determined shadow can depend upon a number of factors, including but not limited to the position of the sun as determined in advance from astronomical data, such as day of the year, time of day, and geographic location.

Embodiments of the disclosed subject matter can employ imaging devices to monitor the clouds and/or the shadows caused by the clouds, for example, as described in detail in U.S. Publication No. 2011/0220091, published Sep. 15, 2011 and entitled “Methods and Apparatus for Operating a Solar Energy System to Account for Cloud Shading,” which is hereby incorporated by reference. According to embodiments, an imaging device is used to supplement or augment results of radiation measuring devices. The radiation measuring devices provide radiation measurements and the image adds boundaries to the cloud shading.

For accurate estimating or calculating projection of a sky imaging device onto the ground, more information on the clouds may be helpful. For example the angle of the sun in the sky combined with the height of the cloud in the sky can determine the size, shape and location of the cloud's shadow on the ground. This information may be obtained, for example, by utilizing any one of the methods described below. More than one sky imaging device may be useful for estimating or calculating the projection of a cloud's image from the sky onto the ground as two or more sky cameras image the same cloud from different places. Stereoscopic imaging can be used to estimate the height of the clouds. Another method for estimating cloud height is using ambient weather conditions and weather reports to determine probable cloud height and using the information about the type of clouds to estimate the cloud height. Another method for estimating cloud height is by using a ceilometer or a similar device that measures cloud height. Ceilometers are expensive but are very accurate for cloud height estimation. They emit pulses, such as laser pulses, into the atmosphere and analyze the backscatter. Other methods for estimating/calculating the projection of clouds on the ground and/or cloud height are also possible according to one or more contemplated embodiments.

It may also be useful to use the angle of the sun in the sky for calculating DNR for use in Eqn. (1) above. There are numerous means known to those skilled in the art to obtain the angle of the sun in the sky, for example, by using a Solar Position Algorithm (SPA) and/or by the use of available meteorological information.

By using prediction algorithms based on the cloud imaging device images and the radiation maps, the movement of the clouds may be predicted, which can be useful in operation of the heliostats in the solar field.

According to one or more embodiments of the disclosed subject matter, images representative of cloud shadows with respect to a field of heliostats can be used to adjust operation of a solar energy system. For example, images of a field of heliostats and shadows produced by the clouds can be obtained. Additionally or alternatively, images of the sky and clouds can be obtained. The images can be analyzed to determine a shading parameter. Based on the shading parameter, an operating parameter of the solar energy system can be changed or maintained. For example, the operating parameter may include aiming directions for one or more of unshaded heliostats in the heliostat field. Cloud characteristics in addition to the location of the cloud shadow can be used in determining the shading parameter. Such characteristics can be used in determining if and/or how to change an operating parameter of the solar energy system. For certain cloud characteristics, it may be determined to maintain current operation of the solar energy system despite the shadow.

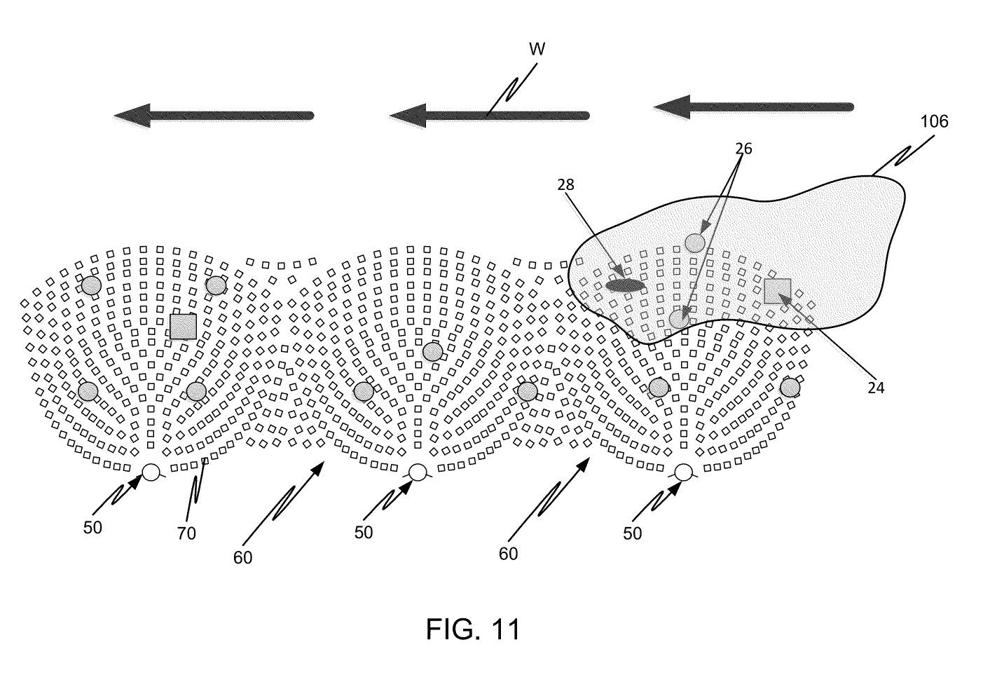

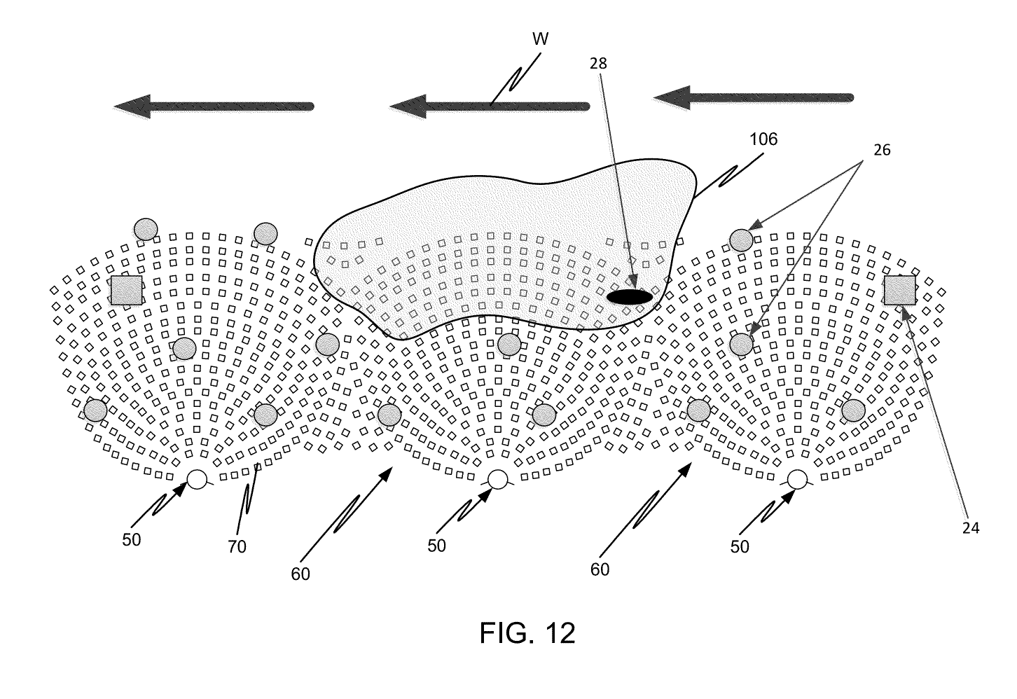

FIG. 11 illustrates a large area consisting of solar fields 60 which may include a number of receiving towers 50 and a plurality of heliostats 70. In the solar field there may be a number of DH measuring/calculating devices (at a first distribution of points) 24 and a number of GH measuring devices (at a second distribution of points) 26. The number of GH measuring devices may be much greater than the number of DH measuring devices. A cloud shadow 106 is illustrated as shading a portion of the rightmost solar field. One DH measuring device 24 and two GH measuring devices 26 are shown within the cloud shaded area 106. The point of interest 28 of the third distribution of points is within cloud shadow 106 according to the cloud map. A DNR value for the cloud may be calculated in accordance with Eqn (1). In some embodiments, a wind may blow the clouds across the multiple solar fields. The arrows, W, show the wind blowing the cloud from the right to the left such that the clouds move to the position shown in FIG. 12.

A new position of shading of cloud 106 is depicted in FIG. 12. In this figure, cloud 106 is mostly over the middle field of the three fields where there are a limited number of radiation-measuring devices. The closest DH measuring device 24 and GH measuring device 26 (which are not within the cloud shade at this time point) may be used for interpolating the shading data over both time and space, by using the data gathered from cloud 106 by these sensors in the previous time point depicted in FIG. 11. Even though there is only one point 28 illustrated in FIGS. 10-12 representing the third distribution of points, the number of points in the third distribution is unlimited as long as it is within the area of the shadow of the cloud and is assumed to have approximately the same value of radiation. This third distribution of points may therefore be denser than the first and second distribution of points, which relate to measuring devices positions.

Features of the disclosed embodiments may be combined, rearranged, omitted, etc., within the scope of the invention to produce additional embodiments. Furthermore, certain features may sometimes be used to advantage without a corresponding use of other features.

It is thus apparent that there is provided in accordance with the present disclosure, system, methods, and devices for mapping cloud shading on the ground in a large area. Many alternatives, modifications, and variations are enabled by the present disclosure. While specific embodiments have been shown and described in detail to illustrate the application of the principles of the present invention, it will be understood that the invention may be embodied otherwise without departing from such principles. Accordingly, Applicants intend to embrace all such alternatives, modifications, equivalents, and variations that are within the spirit and scope of the present invention.

1. A method for mapping cloud shading on the ground in a large area, comprising:
measuring diffuse solar radiation received at a first spatial distribution of points in a large area to generate an estimation of the distribution of diffuse horizontal radiation (DH) over at least a part of the large area;
measuring global solar radiation received at a second spatial distribution of points in the large area to generate an estimation of the distribution of global horizontal radiation (GH) over at least a part of the large area;
receiving an image responsive to light from the sky or the ground to generate an estimation of spatial distribution of clouds on the ground in at least part of the large area (cloud map); and
combining DH, GH, and estimating the sun's angle with the cloud map to generate an estimate of direct normal radiation (DNR) at a third spatial distribution of points in the large area,
wherein the second distribution has a higher density of points than the first distribution.

2. The method of claim 1, wherein the third distribution has a higher density than the second distribution.

3. The method of claim 2, further comprising determining the height of the clouds.

4. The method of claim 3, wherein cloud height is determined by the use of at least one of: at least two cameras, a ceilometer and cloud-weather information.

5. The method of claim 1 or 2, wherein the combining includes deriving DNR from the equation:
$$DNR = \frac{GH - DH}{cos ( {θ}_{Z} )} .$$

6. The method of claim 1, wherein the combining includes deriving an initial estimate of the DNR at said second distribution of points and extrapolating to said third distribution of points.

7. The method of claim 6, wherein said extrapolating includes classifying a point of third distribution according to whether direct radiation from the sun at that point is shadowed by a cloud responsively to the cloud map.

8. The method of claim 1, wherein the large area comprises one or more heliostats for redirecting insolation toward a solar target.

9. The method of claim 8, further comprising controlling the heliostats responsively to said estimate of DNR.

10. A method for mapping cloud shading on the ground in a large area, comprising:
measuring direct normal radiation received at a first spatial distribution of points in a large area to generate an estimation of the distribution of direct normal radiation (DNR) over the large area;
measuring global solar radiation received at a second spatial distribution of points in the large area to generate an estimation of the distribution of global horizontal radiation (GH) over the large area;
receiving an image responsive to light from the sky or the ground to generate an estimation of spatial distribution of clouds (cloud map); and
combining DNR, and GH and estimating the sun's angle with the cloud map to generate an estimate of direct normal radiation (DNR) at a third distribution of points in the large area,
wherein the second distribution has a higher density than the first distribution.

11. The method of claim 10, wherein the third distribution has a higher density than the first or the second distribution.

12. The method of claim 10, wherein the combining includes deriving an initial estimate of the DNR at said second distribution of points and extrapolating to said third distribution of points.

13. The method of claim 12, wherein said extrapolating includes classifying a point of third distribution according to whether direct radiation from the sun at that point is shadowed by a cloud responsively to the cloud map.

14. The method of claim 10, wherein large area comprises a solar field comprising one or more heliostats for redirecting insolation toward a solar target.

15. The method of claim 14, further comprising controlling the heliostats responsively to said estimate of DNR.

16. The method of claim 10, further comprising determining the height of the clouds, and an estimate of the angle of the sun if the image is of the sky.

17. The method of claim 16, wherein cloud height is determined by the use of at least one of: at least two image capturing devices, a ceilometer and cloud-weather information.

18. A method for mapping cloud shading on the ground in a solar energy field, comprising:
measuring at least one of diffused solar radiation (DH) and direct normal radiation (DNR) received at an area defined by a first spatial distribution of points within the solar field to generate an estimation of the distribution of DH and/or DNR over at least part of the solar field;
measuring global solar radiation (GH) received at an area defined by a second spatial distribution of points within the solar field to generate an estimation of the distribution of GH, wherein the second distribution of points has a higher density of points than the first distribution; and
combining solar radiation measured by DH and/or DNR and GH and estimating the sun's angle, to generate an estimate of direct normal radiation (DNR) at a third distribution of points in the solar field.

19. The method of claim 18, further comprising:
receiving an image responsive to light from the sky or the ground to generate an estimation of spatial distribution of clouds on the ground in at least part of the solar field (cloud map),
wherein a shaded area of the solar field is defined by the estimated spatial distribution of clouds.

20. The method of claim 19, wherein the shaded area on the solar field contains none or a small amount of first and/or second distribution of points.

21. The method of claim 20, further comprising using the cloud map to determine which of the points from the first and second distribution shall be used for calculating the solar radiation value in each of the points in the third distribution of points.

22. The method of claim 21, further comprising combining DH and/or DNR solar radiation and GH, with the cloud map to generate an estimate of direct normal radiation (DNR) at a third distribution of points in the solar field.

23. The method of claim 19, further comprising determining the height of the clouds.
